(19) United States
(12) Patent Application Publication
(10) Pub. No.: US 2025/0334708 A1
(43) Pub. Date: Oct. 30, 2025

(54) Detecting Shallow Subsurface Anomalies

(71) Applicant: Saudi Arabian Oil Company, Dhahran (SA)

(72) Inventors: Marcin Szymon DUKALSKI, Delft (NL); Diego ROVETTA, Delft (NL)

(21) Appl. No.: 18/509,812

(22) Filed: Nov. 15, 2023

(51) Int. Cl. G01V 1/30; G01V 1/34

(52) U.S. Cl. CPC G01V 1/306; G01V 1/303; G01V 1/345

(57) ABSTRACT

Systems and methods for detecting shallow subsurface anomalies in a subsurface formation include obtaining seismic data for the subsurface formation; forming one or more seismic gathers by sorting seismic traces from the seismic data into a plurality of bins based on a midpoint and an offset. For bins of the plurality of bins iteratively, encoding a pair of discrete time shifts which are represented by a single binary variable per seismic trace; determining cross-correlations between the seismic traces in the bins to form an objective function based on the encoded discrete time shifts; and determining, by a quantum annealing machine, a set of discrete time-shifts representing the residual refraction statics that maximize stack power for the bins by maximizing the objective function, wherein a next iteration is initialized with a different set of time-shifts than a current iteration. Refraction-based surface-consistent phase corrections are performed for each seismic trace.

### TECHNICAL FIELD

This disclosure generally relates to geological exploration of a subsurface formation.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications such as, for example, identification of potential petroleum reservoirs. Seismic surveys are conducted by using a controlled seismic source (for example, Vibroseis or dynamite) to create a seismic wave. The seismic source is typically located at ground surface. The seismic wave travels into the ground, is reflected by subsurface formations, and returns to the surface where it is recorded by sensors called geophones. The geologists and geophysicists analyze the time it takes for the seismic waves to reflect off subsurface formations and return to the surface to map sedimentary facies and other geologic features. This analysis can also incorporate data from sources such as, for example, borehole logging, gravity surveys, and magnetic surveys.

One approach to this analysis is based on tracing and correlating along continuous reflectors throughout the dataset produced by the seismic survey to produce structural maps that reflect the spatial variation in depth of certain facies. These maps can be used to identify impermeable layers and faults that can trap hydrocarbons such as oil and gas.

### SUMMARY

Geophysics features some of the most challenging optimization problems that can be found in the computational sciences. Those that can be reliably solved, require sufficient data from measurements, efficient algorithms, and enough computing power. Improvements in either of the three aspects facilitate much of the progress in geophysics and help bolster confidence in the information about the subsurface.

Quantum computing is a computational paradigm that can be used to find acceptable solutions to complex optimization problems such as NP-hard combinatorial optimization problems. Traditionally such optimization problems are solved by means of meta-heuristic sampling approaches such as simulated (thermal) annealing (SA) often resulting in very long run times and/or substantially suboptimal solutions (e.g., the solution is not the global maximum or minimum of the problem). Quantum Annealers (QAs) are a type of quantum computer built for solving complex optimization problems. The QAs are initiated in a superposition of all solutions to the problem, and through a myriad of quantum phenomena (such as quantum tunneling) the QAs coalesce to the global optimum solution. The problems where QAs can offer an advantage over classical processing are problems featuring a small number of variables and with the number of viable solutions (as well as local optima) scaling exponentially with the number of variables.

This disclosure describes systems and methods for detecting shallow subsurface anomalies in a subsurface formation based on seismic data using a hybrid classical-quantum solver. A data processing system (e.g., a computer or a control system) obtains seismic data for the subsurface formation. The data processing system forms one or more seismic gathers by sorting seismic traces from the seismic data into multiple bins based on a midpoint and an offset between a source and a receiver associated with the seismic traces. The data processing system estimates residual refraction statics representing the shallow subsurface anomalies for each bin by iteratively encoding discrete time-shifts represented as a single binary variable per seismic trace to form a binary partition, determining cross-correlations between the seismic traces in the bin to form an objective function for the binary partition based on the encoded discrete time shifts. The objective function of the binary partition includes a constant term. The data processing system determines a set of discrete time-shifts representing the residual refraction statics that maximize stack power for the bin by maximizing the objective function using a quantum annealing machine. The data processing system initializes the next iteration on the quantum annealing machine with a different set of time-shifts than the current iteration. The data processing system performs refraction-based surface-consistent phase correction to each seismic trace by applying the estimated residual refraction statics.

The size of a quantum computer (the number of qubits) limits the size of problems that can be solved natively on the quantum computer prohibiting solving problems at industrial scale (e.g., alignment of tens or hundreds of traces with more than two discrete shifts to choose from). Problems that do fit on the quantum computer (e.g., alignment of ˜10 traces) can give an incorrect output, since the quantum native formulation can be dominated by noise resulting from mapping the problem onto the quantum computer (e.g., due to a large penalty factor in front of the constraints that is added on to the optimization).

To overcome these challenges, the systems and methods of this disclosure reformulate the stack power maximization problem for implementation on a hybrid classical-quantum solver. The stack power maximization problem is iteratively partitioned by the classical portion of the solver and the quantum portion of the solver solves the partitioned optimization problems. The objective function for each partition determined by the classical portion includes a constant term enabling comparison of the results from the quantum solver for different partitions generated by the classical portion. The classical portion of the solver can adjust the set of time-shifts input to the quantum solver between iterations to avoid having the classical portion get stuck generating partitions that do not include the global maximum.

Implementations of the systems and methods of this disclosure can provide various technical benefits. The hybrid classical-quantum solver can find the global stack power maximization without getting stuck in a local optimum. Maximizing the stack power reduces distortions in the seismic data improving the quality of the seismic images and improving seismic velocity models. The hybrid classical-quantum solver can find below seismic resolution residual shifts reducing distortions in the seismic data that are not able to be detected using methods such as tomography or full waveform inversion. As quantum computers become larger, a better solution to the stack power maximization problem may be found orders of magnitude faster with a quantum annealer than with, for example, a simulated annealing algorithm using comparable amounts of classical and quantum computation resources.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a seismic survey being performed to map subsurface features such as facies and faults.

FIG. 2 illustrates a three-dimensional cube representing the seismic data in the CMP-offset domain.

FIG. 3 illustrates a stratigraphic trace within a formation.

FIGS. 4A-4C illustrate the process of stacking a group of seismic traces to improve the signal to noise ratio of the traces.

FIGS. 5A-5B are each flowcharts of respective methods for detecting shallow subsurface anomalies.

FIG. 6 is a composite plot showing results from an implementation of the method of FIG. 5A.

FIG. 7 illustrates hydrocarbon production operations that include field operations and computational operations, according to some implementations.

FIG. 8 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes systems and methods for detecting shallow subsurface anomalies in a subsurface formation based on seismic data using a quantum annealing machine. A data processing system (e.g., a computer or a control system) obtains seismic data for the subsurface formation. The data processing system forms one or more seismic gathers by sorting seismic traces from the seismic data into multiple bins based on a midpoint and an offset between a source and a receiver associated with the seismic traces. The data processing system estimates residual refraction statics resulting from the shallow subsurface anomalies for each bin by iteratively encoding discrete time-shifts represented as a single binary variable per seismic trace to from a binary partition, determining cross-correlations between the seismic traces in the bin to form an objective function for the binary partition based on the encoded discrete time shifts. The objective function for the binary partition includes a constant term. The data processing system determines a set of discrete time-shifts representing the residual refraction statics that maximize stack power for the bin by maximizing the objective function using the quantum annealing machine. The data processing system initializes the next iteration on the quantum annealing machine with a different set of time-shifts than the current iteration. The data processing system performs refraction-based surface-consistent phase correction to each seismic trace by applying the estimated residual refraction statics.

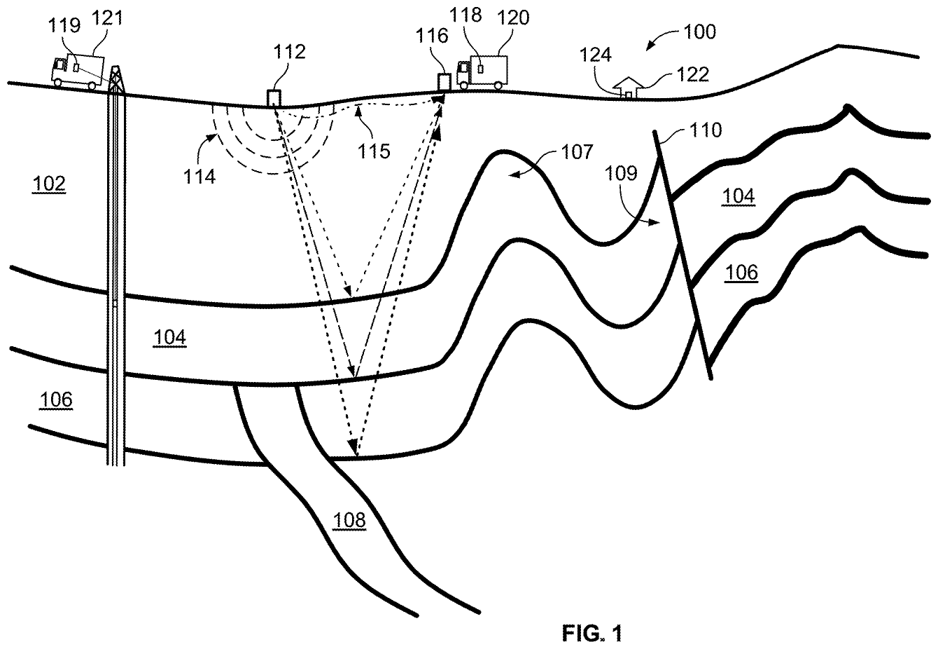

FIG. 1 is a schematic view of a seismic survey being performed to map subsurface features such as facies and faults in a subsurface formation 100. The subsurface formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

A seismic source 112 (for example, a seismic vibrator or an explosion) generates seismic waves 114 that propagate in the earth. The velocity of these seismic waves depends on properties such as, for example, density, porosity, and fluid content of the medium through which the seismic waves are traveling. Different geologic bodies or layers in the earth are distinguishable because the layers have different properties and, thus, different characteristic seismic velocities. For example, in the subsurface formation 100, the velocity of seismic waves traveling through the subsurface formation 100 will be different in the sandstone layer 104, the limestone layer 106, and the sand layer 108. As the seismic waves 114 contact interfaces between geologic bodies or layers that have different velocities, the interface reflects some of the energy of the seismic wave and refracts part of the energy of the seismic wave. Such interfaces are sometimes referred to as horizons.

The seismic waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subsurface formation 100. The sensors 116 can be geophone-receivers that produce electrical output signals transmitted as input data, for example, to a computer 118 on a seismic control truck 120. Based on the input data, the computer 118 may generate a seismic data output such as, for example, a seismic two-way response time plot.

A control center 122 can be operatively coupled to the seismic control truck 120 and other data acquisition and wellsite systems. The control center 122 may have computer facilities for receiving, storing, processing, and/or analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subsurface formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subsurface formation or performing simulation, planning, and optimization of production operations of the wellsite systems.

In some implementations, results generated by the computer system 124 may be displayed for user viewing using local or remote monitors or other display units. One approach to analyzing seismic data is to associate the data with portions of a seismic cube representing the subsurface formation 100. The seismic cube can also display results of the analysis of the seismic data associated with the seismic survey.

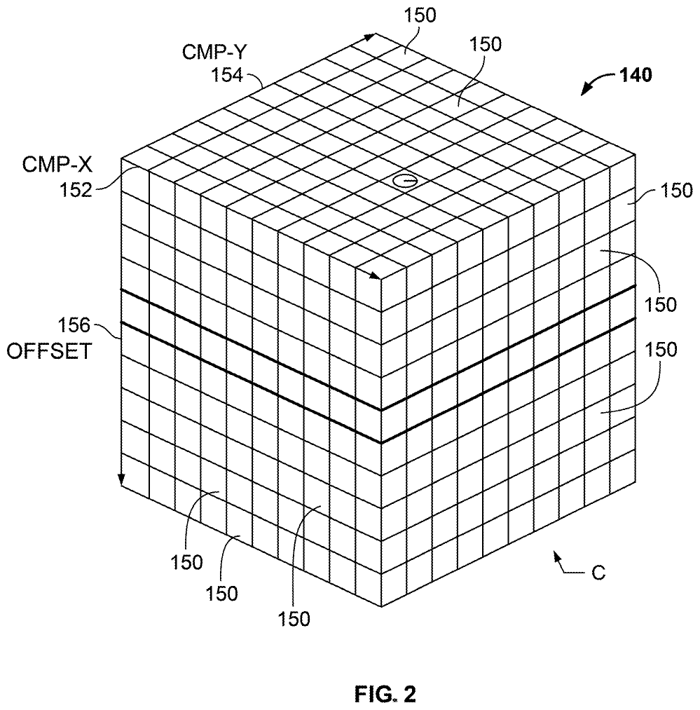

FIG. 2 illustrates a seismic cube 140 representing the seismic data. The seismic cube 140 is composed of a number of voxels 150. A voxel is a volume element, and each voxel contains seismic data, for example, seismic traces and its attributes such as first arrival travel times. The cubic volume C is composed along intersection axes of CMP-offset spacing data based on a Delta-X CMP-X spacing 152, a Delta-Y CMP-Y spacing 154, and a Delta-Offset offset spacing 156. Within each voxel 150, statistical analysis can be performed on data assigned to that voxel to determine, for example, multimodal distributions of traces attributes such as travel times and derive robust estimates (according to mean, median, mode, standard deviation, kurtosis, and other suitable statistical accuracy analytical measures) related to azimuthal sectors allocated to the voxel 150.

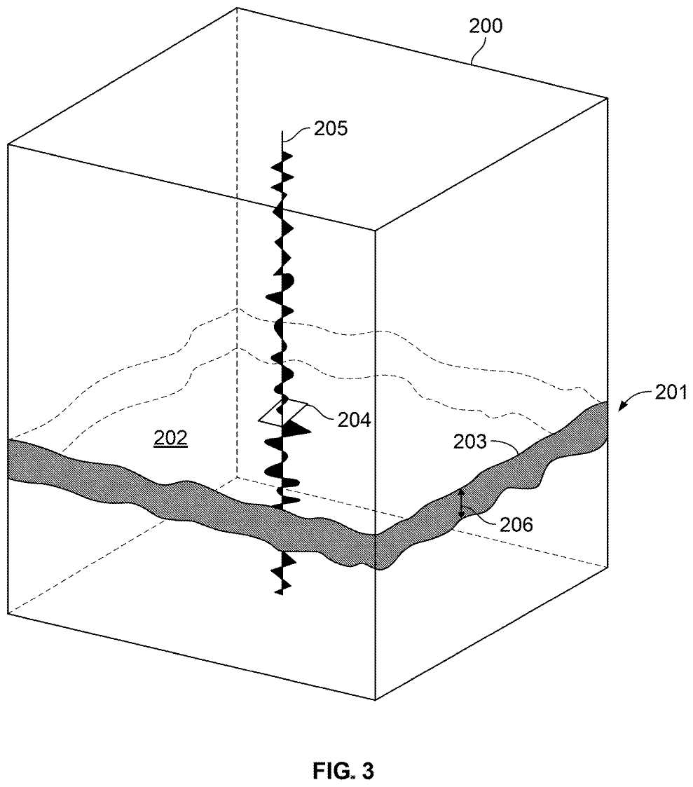

FIG. 3 illustrates a seismic cube 200 representing a formation. The seismic cube has a stratum 201 based on a surface (for example, amplitude surface 202) and a stratigraphic horizon 203. The amplitude surface 202 and the stratigraphic horizon 203 are grids that include many cells such as exemplary cell 204. Each cell is a seismic trace representing an acoustic wave. Each seismic trace has an x-coordinate and a y-coordinate, and each data point of the trace corresponds to a certain seismic travel time or depth (t or z). For the stratigraphic horizon 203, a time value is determined and then assigned to the cells from the stratum 201. For the amplitude surface 202, the amplitude value of the seismic trace at the time of the corresponding horizon is assigned to the cell. This assignment process is repeated for all of the cells on this horizon to generate the amplitude surface 202 for the stratum 201. In some instances, the amplitude values of the seismic trace 205 within window 206 by horizon 203 are combined to generate a compound amplitude value for stratum 201. In these instances, the compound amplitude value can be the arithmetic mean of the positive amplitudes within the duration of the window, multiplied by the number of seismic samples in the window.

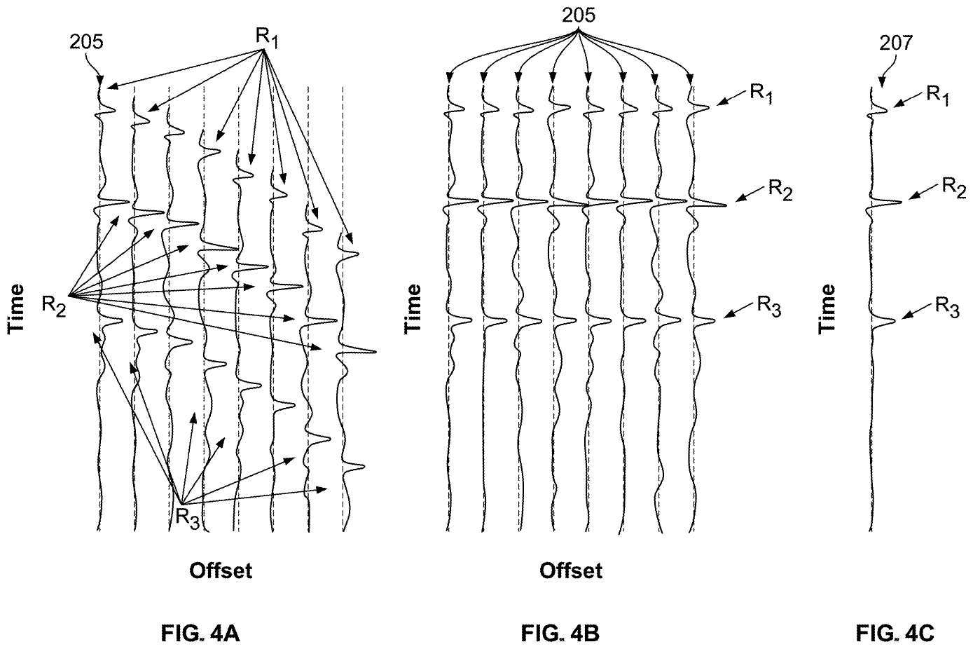

FIGS. 4A, 4B, and 4C schematically illustrate the process of stacking a group of seismic traces 205 to improve the signal to noise ratio of the traces. FIG. 4A illustrates a common midpoint (CMP) gather of eight traces 205 generated by a set of sources and sensors that share a common midpoint. For ease of explanation, the traces are assumed to have been generated by reflections from three horizontal horizons.

The traces 205 are arranged with increasing offset from the CMP. The offset of the traces 205 from the CMP increases from left to right and the reflection time increases from top to bottom. Increasing offset from the common midpoint increases the angle of a seismic wave between a source and a sensor, which increases the distance the wave travels between the source and the sensor and increases the slant reflection time. The increasing time for the reflections (R₁, R₂, R₃) from each of the horizons to arrive for source-sensor pairs with increasing offsets from the CMP reflects this increased slant time.

FIG. 4B shows the traces 205 after normal moveout (NMO) correction. NMO is the difference between vertical reflection time and the slant reflection time for a given source-sensor pair. This correction places reflections (R₁, R₂, R₃) from common horizons at the same arrival time. The NMO correction is a function of the vertical reflection time for a specific horizon, the offset for a specific source-sensor pair, and the velocity of the seismic wave in the subsurface formation. The vertical reflection time for a specific horizon and the offset for a specific source-sensor pair are known parameters for each trace. However, the velocity is usually not readily available. As previously discussed, the velocity of seismic waves depends on properties such as, for example, density, porosity, and fluid content of the medium through which the seismic waves are traveling and consequently varies with location in the subsurface formation being studied.

FIG. 4C shows a stack trace 207 generated by summing the traces 205 of the CMP gather and dividing the resulting amplitudes by the number of traces in the gather. The number of traces in the gather is also referred to as the fold of the gather. The noise tends to be cancelled out and the reflections (R₁, R₂, R₃) from the horizons of the subsurface formation are enhanced.

The systems and methods of this disclosure estimate anomaly attributes to characterize the shallow subsurface, a process called Residual Refraction Statics Estimation (RRSE), through Stack Power Maximization (SPM) with a quantum annealer. SPM is a process for aligning seismic traces in a seismic gather (e.g., seismic traces 205) by maximizing the magnitude of the sum of the squared amplitudes of each trace. SPM is a global optimization problem where the global maximum of the objective function can be difficult to find because the objective function can be very complex and highly multi-modal. QA can be successful in situations where other advanced global optimization techniques (e.g., simulated annealing, genetic algorithms, etc.) may fail or take too long to converge. Using a QA for SPM can solve the cycle-skipping problem affecting classical optimization algorithms and find the optimal solution to the SPM. Cycle-skipping can occur, for example, if events in predicted data occur more than a half cycle away from corresponding events in recorded data resulting in a data misalignment.

QAs solve problems by mapping the objective function of a problem of interest onto the energy landscape of the Ising Model (IM), along with its hardware graph given by a so-called Hamiltonian (the operator determining/including the information about the energy of the system):

$$H ( t ) = f ( t ) {H}_{IM} + ( 1 - f ( t ) ) {H}_{{drive}^{▪}} . \qquad ( 1 )$$

Here, ƒ(t) is some smooth function of time t, with

$$f ( 0 ) = 0 and {lim}_{t \to T} f ( t ) = 1.$$

H_{IM} is the Hamiltonian that represents the problem of interest and H_{drive} encodes the simple problem whose global optimum is known a priori. Moreover,

$${H}_{IM} = {\sum }_{i ∈ V} {h}_{i} {σ}_{z , i} + {\sum }_{( i , j ) ∈ E} {J}_{ij} {σ}_{z , i} {σ}_{z , j} , \qquad ( 2 )$$

where

$${σ}_{z , i} = {1}_{2}^{⊗ i - 1} ⊗ {σ}_{z} ⊗ {1}_{2}^{⊗ N - i}$$

are the Pauli σ_{z}=diag[1, −1] matrices and 1₂=diag[1,1], N is the number of qubits, hᵢ are the energies (biases) of individual spins (the magnetic models), and Jᵢⱼ are the coupling/interaction strengths.

$${H}_{drive} = {\sum }_{i ∈ V} {σ}_{x , i} , \qquad ( 3 )$$

where

$${σ}_{x , i} = {1}_{2}^{⊗ i - 1} ⊗ {σ}_{x} ⊗ {1}_{2}^{⊗ N - i} ,$$

σₓ={{0,1}, {1,0}} is the Pauli matrix, and 1₂={{1,0}, {0,1}} is a two-by-two identity matrix. The tensor product in the superscript signifies that the tensor is multiply nested. In the case of the identity matrix as used here, this notation results in a larger identity matrix. For example,

$${1}_{2}^{⊗ 2}$$

amounts to replacing each “1” in a two-by-two identity matrix with another two-by-two identity matrix to form a four-by-four identity matrix, and

$${1}_{2}^{⊗ k}$$

is a 2^{k} by 2^{k} identity matrix. Furthermore,

$${σ}_{x} ⊗ {1}_{2}^{⊗ m}$$

amounts to replacing each “1” in the Pauli σₓ matrix with a 2^{m} by 2^{m} identity matrix and each zero with a 2^{m} by 2^{m} matrix of zeros. Finally,

$${1}_{2}^{⊗ k} ⊗ {σ}_{x} ⊗ {1}_{2}^{⊗ m}$$

is a matrix where every “1” in and

$${1}_{2}^{⊗ k}$$

(the 2^{k} by 2^{k} identity matrix) is replaced with a matrix,

$${σ}_{x} ⊗ {1}_{2}^{⊗ m} ,$$

and every zero is replaced by a matrix of zeros of the same size as,

$${σ}_{x} ⊗ {1}_{2}^{⊗ m} .$$

The objective function of the problem is mapped onto a Hamiltonian in equation (2), which also defines all the values of hᵢ for each vertex and Jᵢⱼ of each edge on the graph G, by means of physically fixing the biases and the coupling strengths. The QA anneals a specific Ising model with a machine graph G′ that almost always differs from G. In order to anneal the problem of interest (with graph G), it needs to be embedded onto graph G′. The larger and more interconnected G′ is, the larger and more interconnected graphs G can be embedded. Construction of the next generation of quantum annealers amounts to balancing the increase in the qubit-qubit connectivity, while not making the device overall noisier and harder to control.

If the transition between the two Hamiltonians takes place slowly enough (e.g., adiabatically, with large T) the system remains in the global optimum in spite of the underlying change, which ensures that the final state of the machine will correspond to a global optimum of the problem of interest. The QA is capable of resolving multi-modal objective functions where only a global optimum is of interest. The QAs can find global optima quicker than classical meta-heuristic approaches and can offer additional certainty that the best (optimal) solution has been found.

The optimization problem is formulated as a quadratic unconstrained binary optimization (QUBO) problem of the form:

$${min}_{x ∈ {\{ 0 , 1 \}}^{n}} {x}^{T} Qx , \qquad ( 4 )$$

where Q is an upper triangular real matrix and x and its transpose x^{T} are vectors of binary variables xᵢ with the property

$${x}_{i}^{2} = {x}_{i} ,$$

e.g., takin values 0 or 1. The entries of Q can be mapped to those of hᵢ and Jᵢⱼ from equation (2) through the transformation xᵢ=(σᵢ+1₂)/2.

The QUBO formulation includes three steps. First, determining the discretization and solution space. This includes deciding what values the time-shift variables τᵢ will be allowed to take. Second, expressing the objective function in terms of the time-shift operators and establishing the encoding, where such discrete shifts are expressed in terms of the binary variables xᵢ. Third, checking if upon the chosen encoding the problem is indeed a QUBO and/or if it is still a SPM objective function with physically meaningful solutions. If the chosen encoding is not a QUBO or is not a SPM objective function with physically meaningful solutions, additional steps are needed to make it so (if possible). For example, if the problem is not a QUBO, it may be a higher order binary optimization (a HOBO). The higher order terms can be broken down into a set of new variables which each have at most quadratic interactions making the problem a series of QUBOs. The series of QUBOs can then be iteratively solved by using a hybrid classical and quantum solver.

In the first step a solution space (e.g., all the allowable values) of the shift variable τᵢ is denoted as S_{i,K} S_{K} {t₁, . . . , t_{K}}. The same set of possible shifts is assumed for all traces, e.g., for all of the shift variables τᵢ, and the index i on S_{K} is dropped hereafter. Moreover, we assume that tₖ=k dt, where dt is some chosen small time interval and k is an integer. The choice of solution space affects the problem size and the energy landscape of the quantum annealer. For example, if a simple solution set is chosen (e.g., K=3), where t₁=0, and t₂=−t₃=2 ms, any relative shift larger than 4 ms will not be a part of the solution. A good choice of K or the exact values of tₐ can be based on the data used. Note that adding a constant to all elements of S_{K} will have no impact on the solution, as this operation would introduce an overall shift to a gather and hence not influence the trace alignment. The relative shift can become a problem when carrying out trace alignment for multiple gathers, as relative alignment between gathers is lost.

The SPM can be expressed using discrete variables δₓ_{ᵢ}ₐ:

$${arg max}_{x ∈ {\{ 1 , ... , K \}}^{M}} {\sum }_{i = 1}^{M} {\sum }_{a = 1}^{K} {( {δ}_{{x}_{i} a} )}^{2} 〈 {d}_{i} ( {t}_{a} ) , {d}_{i} ( {t}_{a} ) 〉 + 2 {\sum }_{i = 1}^{M} {\sum }_{j = i + 1}^{M} {\sum }_{a = 1}^{K} {\sum }_{b = 1}^{K} {δ}_{{x}_{i} a} {δ}_{{x}_{j} b} 〈 {d}_{i} ( {t}_{a} ) , {d}_{j} ( {t}_{b} ) 〉 , \qquad ( 5 )$$

where (dᵢ(tₐ), dⱼ(t_{b})) is the inner product (e.g., the cross-correlation evaluated at t=0) between the i^{th} and the j^{th} traces shifted by tₐ and t_{b}, respectively. The term

$$〈 {d}_{i} ( {t}_{a} ) , {d}_{i} ( {t}_{a} ) 〉 = {‖ {d}_{i} ( {t}_{a} ) ‖}_{2}^{2} = {‖ {d}_{i} ‖}_{2}^{2}$$

is a constant independent of tₐ, and hence it can be dropped, as it does not affect the solution for the full problem.

The inner products [symbol] dᵢ(tₐ), dⱼ (t_{b}) [symbol] for all possible pairs of time shifts and traces can be calculated in a number of ways, in particular using:

$$〈 {d}_{i} ( {t}_{a} ) , {d}_{j} ( {t}_{b} ) 〉 = {\sum }_{ω} {ℱ [ {d}_{i} ( 0 ) ]}^{*} ℱ [ {d}_{j} ( 0 ) ] {e}^{i ω ( {t}_{a} - {t}_{b} )} , \qquad ( 6 )$$

where ℑ denotes the Fourier transform. Here, the sum is over all frequencies ω, and * denotes complex conjugation. The Fourier transforms are calculated only once per trace, and maximally only K(K−1) possible combinations of e^{iω(t}^{ₐ}^{-t}^{_{b}}⁾ are required, hence this is not a near-brute-force sampling approach (which would require calculating K^{M} possible stack powers).

Next, the discrete variables δₓ_{ᵢ}ₐ are expressed in terms of binary variables xᵢₐ using a binary partitioning approach, which includes iteratively solving the problem from equation (5) using just two shift choices T_{i,0} or T_{i,1}. The two shift choices can be very efficiently encoded using a constraint-free single binary encoded variable per trace, instead of two variables using a one-hot encoding with a constraint. The shift parameters T_{i,0} or T_{i,1} can be specified independently for each trace and changed during iteration. In this case the objective function for a single iteration takes the form:

$${J}_{bin} = {\sum }_{i , j = 1}^{M} {\sum }_{a , b = 0}^{1} {c}_{ia} {c}_{jb} 〈 {d}_{i} ( {T}_{i , a} ) , {d}_{j} ( {T}_{j , b} ) 〉 , \qquad ( 7 )$$

where the binary encoding polynomials cᵢ₀=1−xᵢ and cᵢ₁=xᵢₐ are used if shifts T_{O} or T₁ are to be applied, respectively. For more than two shifts, cᵢₐ are non-linear in xᵢₐ, and J_{bin} is no longer a QUBO. All qubit configurations are meaningful, enabling current state-of-the-art quantum annealers to align up to about M=170 traces (which is dependent on the exact quantum annealer this is ran on) at the same time, and hence find the best out of the 2¹⁷⁰≈10⁵¹ possible configurations. Tests have shown that the quantum annealer returns the global optimum for this sub problem with a probability in excess of 80%, meaning that only a few annealing samples need to be ran to find the best outcome.

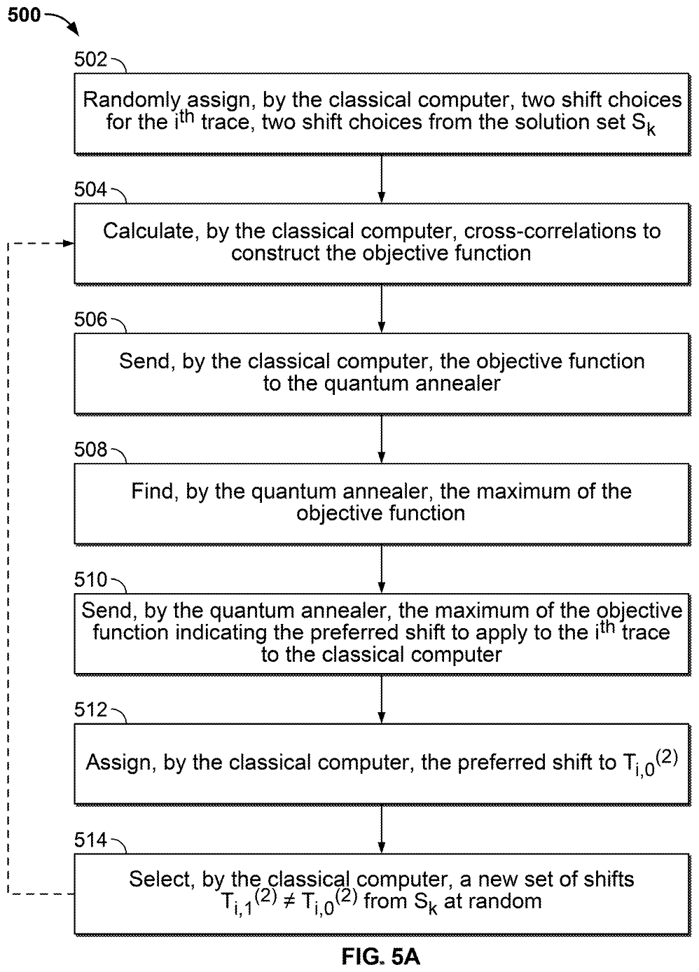

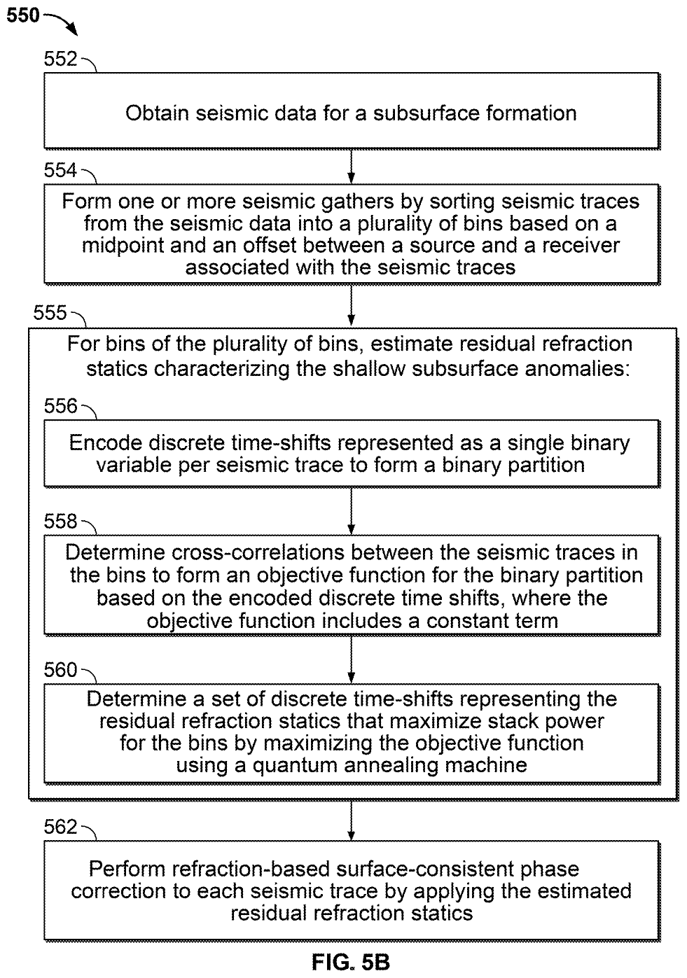

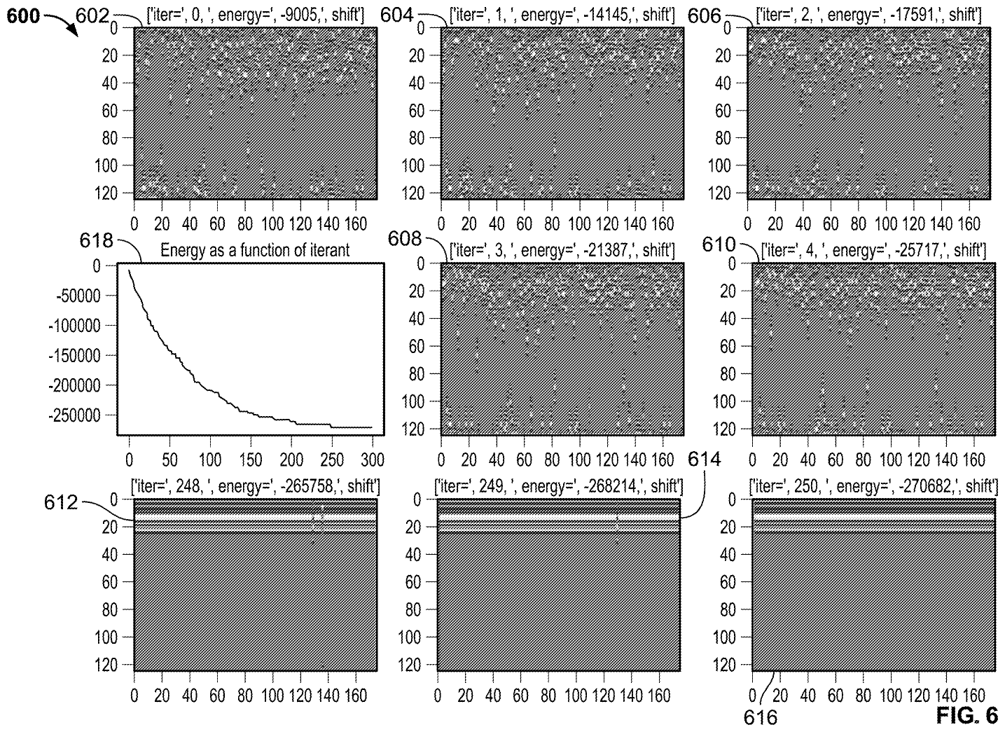

FIG. 5A is an example workflow 500 for the binary partitioning approach. For the first iteration (see the upper index ⁽¹⁾), the classical computer randomly assigns for the i^{th} trace two shift choices

$${T}_{i , 0}^{( 1 )} and {T}_{i , 1}^{( 1 )}$$

from the solution set S_{K}={t₁, . . . , t_{K}} (step 502). S_{K} can include a series of consecutive integer multiples of some small time interval, dt. The classical computer uses equation 6 to calculate the relevant cross-correlations from equation 7 to construct J_{bin} (step 504). The classical computer sends the objective function, J_{bin}, to the quantum annealer (step 506). The quantum annealer finds the maximum of the objective function (step 508). For example, the quantum annealer finds the lowest energy outcome. The quantum annealer sends the lowest energy outcome to the classical computer (step 510). For example, the lowest energy outcome is represented by a string of bits, which determines whether

$${T}_{i , 0}^{( 1 )} or {T}_{i , 1}^{( 1 )}$$

is the preferred shift to be applied to the i^{th} trace. The classical computer assigns the preferred shift to

$${T}_{i , 0}^{( 2 )}$$

(step 512). The classical computer can determine if any of the preferred shifts are close to the minimum or maximum value of Sₖ, and the classical computer can shift all of the preferred shifts away from the minimum and maximum values of Sₖ. The classical computer selects a new set of shifts

$${T}_{i , 1}^{( 2 )} \neq {T}_{i , 0}^{( 2 )}$$

from S_{K} at random (step 514).

The workflow 500 can repeat steps 504-512 until a satisfactory result is reached or for a specified number of iterations. For every iteration, the QA finds the best configuration among the 2^{M} possible configurations. This approach can asymptotically investigate a practically infinite ˜K^{M} set of possible configurations, however, coming at the cost that after a finite number of iterations, it cannot be strictly ensured that the global optimum was really found. However, experience shows that the solution is found in about K iterations.

For very large search spaces with large numbers of traces and shifts, the workflow 500 can be locked into a sub-optimal configuration which is difficult to leave through the random selection process carried out by the classical computer to establish the binary partition which is outlined above. To address this problem, the classical computer picks S_{K} with a wider set of values than the bare minimum and initiates T_{i,0} in the middle of S_{K} range. In the event that one of the values in T_{i,0} is close to the minval S_{K} or the maxval S_{K}, then the classical computer can shift all values T_{i,0} up or down by the same amount respectively. This gives a higher probability that the quantum annealer accesses the shifts in the solution set which find the global optimum.

The process of resolving the lock in can be illustrated with an example featuring five traces which were scrambled with one of seven possible shifts t₁, t₂, . . . t₇, e.g., with P=[t₇, t₄, t₁, t₂, t₅], which will be abbreviate to [7,4,1,2,5]. Consider a solution space S_{K}={t₀, t₁, . . . , t₇, t₈, t₉}, with tₘ=mt₁, which is identical for every trace. In this setting, performing a reversed shift with P is not the only solution, as a set of shifts P−1, P, P+1, and P+2, also work and can be drawn from S_{K}. The solution P+3 would contain a shift 10, which is not a part of S_{K} and hence is excluded. Suppose that after a few iterations the workflow is at a configuration [5,2, z, 0,3] where the first, second, fourth and fifth trace are perfectly aligned, but the third is not, and cannot be since it would need a shift of z=−1, which is not a part of S_{K}. Similarly, a configuration T_{i,0}=[z, 8,4,5,9] would require z=10 to align the first trace with the rest which are already maximally aligned. The way out of, e.g., the latter configuration requires a considerable chance that the set of, e.g., t_{i,1}=[10,7,3,4,8]−h, where 0<h<3, gets picked, but if the individual T_{i,1} are picked at random from a uniform distribution, the chances of this exact pick here are 4-10⁻⁵. Perhaps other intermediate t_{i,1} would help, but the chances of these are most likely of the same order of magnitude. For larger, industrially relevant problems with hundreds of traces that probability becomes even smaller.

When the steps 502-514 are performed in a loop, where the shifts

$${T}_{i , 0}^{( k )} and {T}_{i , 1}^{( k )}$$

are the time shifts on the k-th iteration, the objective function, J_{bin}, includes a constant term, j_{const}:

$${j}_{const} ( k ) = {\sum }_{i , j = 1}^{M} {\sum }_{a , b = 0}^{1} 〈 {d}_{i} ( {T}_{i , 0}^{( k )} ) , {d}_{j} ( {T}_{j , 0}^{( k )} ) 〉 , \qquad ( 8 )$$

to compare if the optimum found on the (k−1)-th iteration is preferred over the optimum found on the k-th iteration. Failure to include the constant terms j_{const} (k−1) and j_{const}(k)≠j_{const}(k−1) would shift the optima found on the two iterations by a different amount, and hence make it impossible to judge which one is better.

FIG. 5B is a flowchart of an example method 550 for detecting shallow subsurface anomalies in a subsurface formation. A data processing system (e.g., a classical computer, a control system) obtains seismic data for the subsurface formation (step 552). For example, the data processing system can obtain seismic data during a seismic survey such as the seismic survey of FIG. 1. In some implementations, the data processing system obtains the seismic data by accessing a database or a data store.

The data processing system forms one or more seismic gathers by sorting seismic traces from the seismic data into multiple bins based on a midpoint and an offset between a source and a receiver associated with the seismic traces (step 554). For example, the data processing system forms the seismic gathers by sorting the seismic data into common midpoint-X, common midpoint-Y, and offset bins (XYO bins).

At block 555, for each bin, the data processing system estimates residual refraction statics characterizing the shallow subsurface anomalies by iteratively performing steps 556-560.

The data processing system encodes discrete time-shifts represented as a single binary variable per seismic trace to form a binary partition (step 556).

The data processing system determines cross-correlations between the seismic traces in the bins to form an objective function for the binary partition based on the encoded discrete time shifts (step 558). The objective function for the binary partition includes a constant term.

The data processing system determines a set of discrete time-shifts representing the residual refraction statics that maximize stack power for the bins by maximizing the objective function using a quantum annealing machine (step 560). The data processing system initializes the next iteration with a different set of time-shifts than the current iteration.

The data processing system performs refraction-based surface-consistent phase correction to each seismic trace by applying the estimated residual refraction statics (step 562).

In some implementations, the data processing system controls hydrocarbon production equipment to produce hydrocarbons from the subsurface formation based at least in part on the corrected seismic traces. In some implementations, the data processing system is configured to generate a seismic image based on the corrected seismic traces, the seismic image having an improved representation of the near surface relative to a seismic image generated without the corrected seismic traces.

FIG. 6 is a composite plot 600 showing results from an example implementation of the method 550. The method is assessed with synthetic data where the global optimum is known. In this implementation, the hybrid classical-quantum solver finds the global optimum in a relatively small number of iterations. The composite plot shows the gradually improved alignment of 176 identical input traces, which have been shifted by a randomly picked integer multiple of a time sample in the range of 0 to 50, with allowed shifts ranging from 0 to 55. Plot 602 shows the 176 traces with the randomized alignment. Plot 604 shows the results after 1 iteration. Plot 606 shows the results after 2 iterations. Plot 608 shows the results after 3 iterations. Plot 610 shows the results after 4 iterations. Plot 612 shows the results after 248 iterations. Plot 614 shows the results after 249 iterations. Plot 616 shows the results after 250 iterations. Within 250 iterations the solver converged to a global optimum as shown on the energy/convergence function in plot 618.

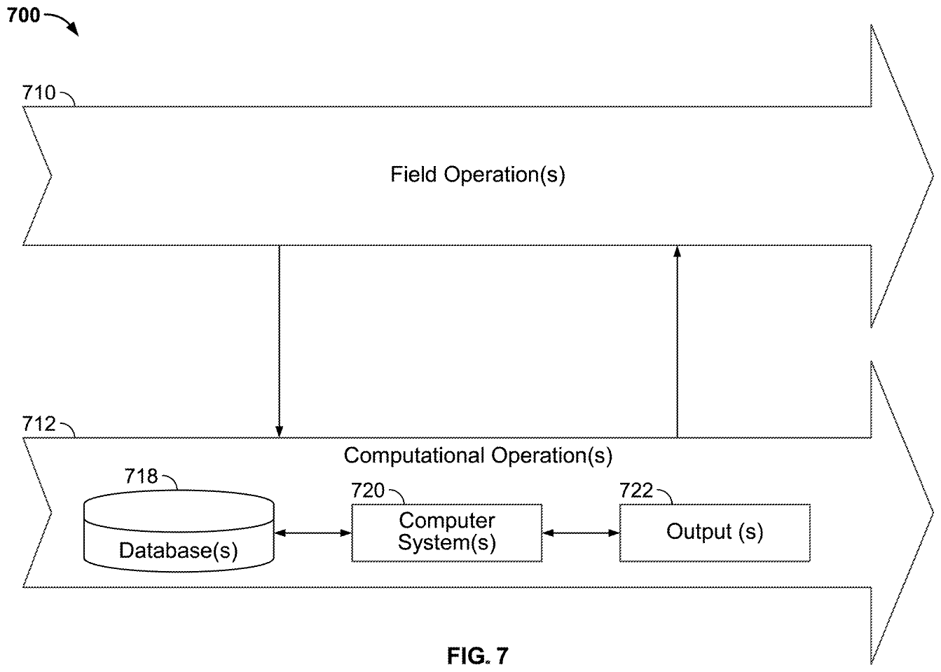

FIG. 7 illustrates hydrocarbon production operations 700 that include both one or more field operations 710 and one or more computational operations 712, which exchange information and control exploration for the production of hydrocarbons. In some implementations, outputs of techniques of the present disclosure (e.g., the method 550) can be performed before, during, or in combination with the hydrocarbon production operations 700, specifically, for example, either as field operations 710 or computational operations 712, or both.

Examples of field operations 710 include forming/drilling a wellbore, hydraulic fracturing, producing through the wellbore, injecting fluids (such as water) through the wellbore, to name a few. In some implementations, methods of the present disclosure can trigger or control the field operations 710. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 710 and responsively triggering the field operations 710 including, for example, generating plans and signals that provide feedback to and control physical components of the field operations 710. Alternatively, or in addition, the field operations 710 can trigger the methods of the present disclosure. For example, implementing physical components (including, for example, hardware, such as sensors) deployed in the field operations 710 can generate plans and signals that can be provided as input or feedback (or both) to the methods of the present disclosure.

Examples of computational operations 712 include one or more computer systems 720 that include one or more processors and computer-readable media (e.g., non-transitory computer-readable media) operatively coupled to the one or more processors to execute computer operations to perform the methods of the present disclosure. The computational operations 712 can be implemented using one or more databases 718, which store data received from the field operations 710 and/or generated internally within the computational operations 712 (e.g., by implementing the methods of the present disclosure) or both. For example, the one or more computer systems 720 process inputs from the field operations 710 to assess conditions in the physical world, the outputs of which are stored in the databases 718. For example, seismic sensors of the field operations 710 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 712 where they are stored in the databases 718 and analyzed by the one or more computer systems 720.

In some implementations, one or more outputs 722 generated by the one or more computer systems 720 can be provided as feedback/input to the field operations 710 (either as direct input or stored in the databases 718). The field operations 710 can use the feedback/input to control physical components used to perform the field operations 710 in the real world.

For example, the computational operations 712 can process the seismic data to generate three-dimensional (3D) maps of the subsurface formation. The computational operations 712 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 712 to process new information about the formation and control the drilling to adjust to the observed conditions in real-time.

The one or more computer systems 720 can update the 3D maps of the subsurface formation as information from one exploration well is received and the computational operations 712 can adjust the location of the next exploration well based on the updated 3D maps. Similarly, the data received from production operations can be used by the computational operations 712 to control components of the production operations. For example, production well and pipeline data can be analyzed to predict slugging in pipelines leading to a refinery and the computational operations 712 can control machine operated valves upstream of the refinery to reduce the likelihood of plant disruptions that run the risk of taking the plant offline.

In some implementations of the computational operations 712, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

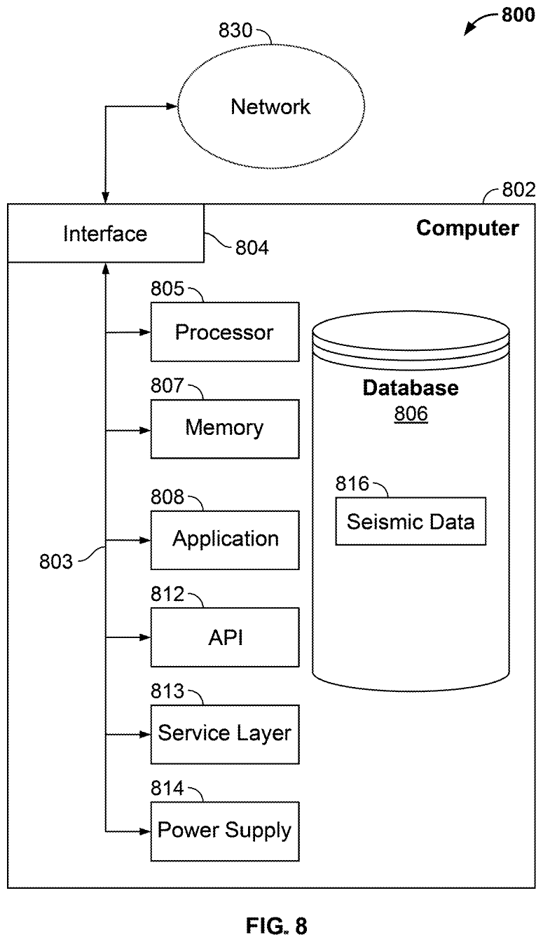

FIG. 8 is a block diagram of an example computer system 800 used to provide computational functionalities associated with described algorithms, methods, functions, processes, flows, and procedures described in the present disclosure, according to some implementations of the present disclosure. The illustrated computer 802 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 802 can include input devices such as keypads, keyboards, and touch screens that can accept user information. Also, the computer 802 can include output devices that can convey information associated with the operation of the computer 802. The information can include digital data, visual data, audio information, or a combination of information. The information can be presented in a graphical user interface (UI) (or GUI).

The computer 802 can serve in a role as a client, a network component, a server, a database, a persistency, or components of a computer system for performing the subject matter described in the present disclosure. The illustrated computer 802 is communicably coupled with a network 830. In some implementations, one or more components of the computer 802 can be configured to operate within different environments, including cloud-computing-based environments, local environments, global environments, and combinations of environments.

At a high level, the computer 802 is an electronic computing device operable to receive, transmit, process, store, and manage data and information associated with the described subject matter. According to some implementations, the computer 802 can also include, or be communicably coupled with, an application server, an email server, a web server, a caching server, a streaming data server, or a combination of servers.

The computer 802 can receive requests over network 830 from a client application (for example, executing on another computer 802). The computer 802 can respond to the received requests by processing the received requests using software applications. Requests can also be sent to the computer 802 from internal users (for example, from a command console), external (or third) parties, automated applications, entities, individuals, systems, and computers.

Each of the components of the computer 802 can communicate using a system bus 803. In some implementations, any or all of the components of the computer 802, including hardware or software components, can interface with each other or the interface 804 (or a combination of both), over the system bus 803. Interfaces can use an application programming interface (API) 812, a service layer 813, or a combination of the API 812 and service layer 813. The API 812 can include specifications for routines, data structures, and object classes. The API 812 can be either computer-language independent or dependent. The API 812 can refer to a complete interface, a single function, or a set of APIs.

The service layer 813 can provide software services to the computer 802 and other components (whether illustrated or not) that are communicably coupled to the computer 802. The functionality of the computer 802 can be accessible for all service consumers using this service layer. Software services, such as those provided by the service layer 813, can provide reusable, defined functionalities through a defined interface. For example, the interface can be software written in JAVA, C++, or a language providing data in extensible markup language (XML) format. While illustrated as an integrated component of the computer 802, in alternative implementations, the API 812 or the service layer 813 can be stand-alone components in relation to other components of the computer 802 and other components communicably coupled to the computer 802. Moreover, any or all parts of the API 812 or the service layer 813 can be implemented as child or sub-modules of another software module, enterprise application, or hardware module without departing from the scope of the present disclosure.

The computer 802 includes an interface 804. Although illustrated as a single interface 804 in FIG. 8, two or more interfaces 804 can be used according to particular needs, desires, or particular implementations of the computer 802 and the described functionality. The interface 804 can be used by the computer 802 for communicating with other systems that are connected to the network 830 (whether illustrated or not) in a distributed environment. Generally, the interface 804 can include, or be implemented using, logic encoded in software or hardware (or a combination of software and hardware) operable to communicate with the network 830. More specifically, the interface 804 can include software supporting one or more communication protocols associated with communications. As such, the network 830 or the interface's hardware can be operable to communicate physical signals within and outside of the illustrated computer 802.

The computer 802 includes a processor 805. Although illustrated as a single processor 805 in FIG. 8, two or more processors 805 can be used according to particular needs, desires, or particular implementations of the computer 802 and the described functionality. Generally, the processor 805 can execute instructions and can manipulate data to perform the operations of the computer 802, including operations using algorithms, methods, functions, processes, flows, and procedures as described in the present disclosure.

The computer 802 also includes a database 806 that can hold data for the computer 802 and other components connected to the network 830 (whether illustrated or not). For example, database 806 can hold seismic data 816. For example, database 806 can be an in-memory, conventional, or a database storing data consistent with the present disclosure. In some implementations, database 806 can be a combination of two or more different database types (for example, hybrid in-memory and conventional databases) according to particular needs, desires, or particular implementations of the computer 802 and the described functionality. Although illustrated as a single database 806 in FIG. 8, two or more databases (of the same, different, or combination of types) can be used according to particular needs, desires, or particular implementations of the computer 802 and the described functionality. While database 806 is illustrated as an internal component of the computer 802, in alternative implementations, database 806 can be external to the computer 802.

The computer 802 also includes a memory 807 that can hold data for the computer 802 or a combination of components connected to the network 830 (whether illustrated or not). Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 (of the same, different, or combination of types) can be used according to particular needs, desires, or particular implementations of the computer 802 and the described functionality. While memory 807 is illustrated as an internal component of the computer 802, in alternative implementations, memory 807 can be external to the computer 802.

The application 808 can be an algorithmic software engine providing functionality according to particular needs, desires, or particular implementations of the computer 802 and the described functionality. For example, application 808 can serve as one or more components, modules, or applications. Further, although illustrated as a single application 808, the application 808 can be implemented as multiple applications 808 on the computer 802. In addition, although illustrated as internal to the computer 802, in alternative implementations, the application 808 can be external to the computer 802.

The computer 802 can also include a power supply 814. The power supply 814 can include a rechargeable or non-rechargeable battery that can be configured to be either user- or non-user-replaceable. In some implementations, the power supply 814 can include power-conversion and management circuits, including recharging, standby, and power management functionalities. In some implementations, the power-supply 814 can include a power plug to allow the computer 802 to be plugged into a wall socket or a power source to, for example, power the computer 802 or recharge a rechargeable battery.

There can be any number of computers 802 associated with, or external to, a computer system containing computer 802, with each computer 802 communicating over network 830. Further, the terms “client,” “user,” and other appropriate terminology can be used interchangeably, as appropriate, without departing from the scope of the present disclosure. Moreover, the present disclosure contemplates that many users can use one computer 802 and one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal.

The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of implementations of these systems and methods have been described. Nevertheless, it will be understood that various modifications may be made without departing from the spirit and scope of this disclosure. Accordingly, other implementations are within the scope of the following claims.

### EXAMPLES

In an example implementation, a method for detecting shallow subsurface anomalies in a subsurface formation includes obtaining seismic data for the subsurface formation; forming one or more seismic gathers by sorting seismic traces from the seismic data into a plurality of bins based on a midpoint and an offset between a source and a receiver associated with the seismic traces; for bins of the plurality of bins, estimating residual refraction statics characterizing the shallow subsurface anomalies by iteratively encoding, by a classical computer, a pair of discrete time shifts which are represented by a single binary variable per seismic trace to form a binary partition; determining, by the classical computer, cross-correlations between the seismic traces in the bins to form an objective function for the binary partition based on the encoded discrete time shifts, where the objective function for the binary partition includes a constant term; and determining, by a quantum annealing machine, a set of discrete time-shifts representing the residual refraction statics that maximize stack power for the bins by maximizing the objective function, wherein a next iteration is initialized, by the classical computer, with a different set of time-shifts than a current iteration; and performing refraction-based surface-consistent phase correction to each seismic trace by applying the estimated residual refraction statics.

An aspect combinable with the example implementation includes causing control of hydrocarbon extraction equipment based at least in part on the corrected refraction-based surface-consistent phases.

In another aspect combinable with any of the previous aspects, the single binary variable per seismic trace represents two different choices for time-shifts selected from a set of possible time-shifts.

In another aspect combinable with any of the previous aspects, the first choice of the two choices represents a preferred time-shift determined by a previous iteration of maximizing the objective function.

In another aspect combinable with any of the previous aspects, the second choice of the two choices is randomly selected from the set of possible time-shifts.

In another aspect combinable with any of the previous aspects, determining a set of discrete time-shifts representing the residual refraction statics that maximize stack power for the bins further includes determining that a value of the time-shifts for one of the seismic traces is near the maximum or the minimum of a range of possible time-shifts; and in response, shifting all of the time-shifts for the bin by a specified amount.

In another aspect combinable with any of the previous aspects, iteratively maximizing the objective function occurs for a predetermined number of iterations.

In another example implementation, a system for detecting shallow subsurface anomalies in a subsurface formation includes a hybrid classical and quantum solver; at least one processor and a memory storing instructions that when executed by the at least one processor cause the at least one processor to perform operations including obtaining seismic data for the subsurface formation; forming one or more seismic gathers by sorting seismic traces from the seismic data into a plurality of bins based on a midpoint and an offset between a source and a receiver associated with the seismic traces; for bins of the plurality of bins, estimating residual refraction statics characterizing the shallow subsurface anomalies by iteratively encoding, by a classical portion of the hybrid classical and quantum solver, a pair of discrete time shifts which are represented by a single binary variable per seismic trace to form a binary partition; determining, by the classical portion, cross-correlations between the seismic traces in the bins to form an objective function for the binary partition based on the encoded discrete time shifts, where the objective function for the binary partition includes a constant term; and determining, by a quantum portion of the hybrid classical and quantum solver, a set of discrete time-shifts representing the residual refraction statics that maximize stack power for the bins by maximizing the objective function, wherein a next iteration is initialized, by the classical portion, with a different set of time-shifts than a current iteration; and performing refraction-based surface-consistent phase correction to each seismic trace by applying the estimated residual refraction statics.

In an aspect combinable with the example implementation, the operations further include causing control of hydrocarbon extraction equipment based at least in part on the corrected refraction-based surface-consistent phases.

In another aspect combinable with any of the previous aspects, the single binary variable per seismic trace represents two different choices for time-shifts selected from a set of possible time-shifts.

In another aspect combinable with any of the previous aspects, the first choice of the two choices represents a preferred time-shift determined by a previous iteration of maximizing the objective function.

In another aspect combinable with any of the previous aspects, the second choice of the two choices is randomly selected from the set of possible time-shifts.

In another aspect combinable with any of the previous aspects, determining a set of discrete time-shifts representing the residual refraction statics that maximize stack power for the bins further includes determining that a value of the time-shifts for one of the seismic traces is near the maximum or the minimum of a range of possible time-shifts; and in response, shifting all of the time-shifts for the bin by a specified amount.

In another aspect combinable with any of the previous aspects, iteratively maximizing the objective function occurs for a predetermined number of iterations.

In another example implementation, one or more non-transitory, machine-readable storage devices storing instructions for detecting shallow subsurface anomalies in a subsurface formation, the instructions being executable by one or more processors, to cause performance of operations including obtaining seismic data for the subsurface formation; forming one or more seismic gathers by sorting seismic traces from the seismic data into a plurality of bins based on a midpoint and an offset between a source and a receiver associated with the seismic traces; for bins of the plurality of bins, estimating residual refraction statics characterizing the shallow subsurface anomalies by iteratively encoding, by a classical portion of the hybrid classical and quantum solver, a pair of discrete time shifts which are represented by a single binary variable per seismic trace to form a binary partition; determining, by the classical portion, cross-correlations between the seismic traces in the bins to form an objective function for the binary partition based on the encoded discrete time shifts, where the objective function for the binary partition includes a constant term; and determining, by a quantum portion of the hybrid classical and quantum solver, a set of discrete time-shifts representing the residual refraction statics that maximize stack power for the bins by maximizing the objective function, wherein a next iteration is initialized, by the classical portion, with a different set of time-shifts than a current iteration; and performing refraction-based surface-consistent phase correction to each seismic trace by applying the estimated residual refraction statics.

In an aspect combinable with the example implementation, the single binary variable per seismic trace represents two different choices for time-shifts selected from a set of possible time-shifts.

In another aspect combinable with any of the previous aspects, the first choice of the two choices represents a preferred time-shift determined by a previous iteration of maximizing the objective function.

In another aspect combinable with any of the previous aspects, the second choice of the two choices is randomly selected from the set of possible time-shifts.

In another aspect combinable with any of the previous aspects, determining a set of discrete time-shifts representing the residual refraction statics that maximize stack power for the bins further includes determining that a value of the time-shifts for one of the seismic traces is near the maximum or the minimum of a range of possible time-shifts; and in response, shifting all of the time-shifts for the bin by a specified amount.

In another aspect combinable with any of the previous aspects, iteratively maximizing the objective function occurs for a predetermined number of iterations.

What is claimed is:

1. A method for detecting shallow subsurface anomalies in a subsurface formation, the method comprising:
obtaining seismic data for the subsurface formation;
forming one or more seismic gathers by sorting seismic traces from the seismic data into a plurality of bins based on a midpoint and an offset between a source and a receiver associated with the seismic traces;
for bins of the plurality of bins, estimating residual refraction statics characterizing the shallow subsurface anomalies by iteratively:
encoding, by a classical computer, a pair of discrete time shifts which are represented by a single binary variable per seismic trace to form a binary partition;
determining, by the classical computer, cross-correlations between the seismic traces in the bins to form an objective function for the binary partition based on the encoded discrete time shifts, wherein the objective function for the binary partition includes a constant term; and
determining, by a quantum annealing machine, a set of discrete time-shifts representing the residual refraction statics that maximize stack power for the bins by maximizing the objective function, wherein a next iteration is initialized, by the classical computer, with a different set of time-shifts than a current iteration; and
performing refraction-based surface-consistent phase correction to each seismic trace by applying the estimated residual refraction statics.

2. The method of claim 1, further comprising:
causing control of hydrocarbon extraction equipment based at least in part on the corrected refraction-based surface-consistent phases.

3. The method of claim 1, wherein the single binary variable per seismic trace represents two different choices for time-shifts selected from a set of possible time-shifts.

4. The method of claim 3, wherein a first choice of the two choices represents a preferred time-shift determined by a previous iteration of maximizing the objective function.

5. The method of claim 4, wherein a second choice of the two choices is randomly selected from the set of possible time-shifts.

6. The method of claim 1, wherein determining a set of discrete time-shifts representing the residual refraction statics that maximize stack power for the bins further comprises:
determining that a value of the time-shifts for one of the seismic traces is near the maximum or the minimum of a range of possible time-shifts; and in response, shifting all of the time-shifts for the bin by a specified amount.

7. The method of claim 1, wherein iteratively maximizing the objective function occurs for a predetermined number of iterations.

8. A system for detecting shallow subsurface anomalies in a subsurface formation, the system comprising:
a hybrid classical and quantum solver;
at least one processor and a memory storing instructions that when executed by the at least one processor cause the at least one processor to perform operations comprising:
obtaining seismic data for the subsurface formation;
forming one or more seismic gathers by sorting seismic traces from the seismic data into a plurality of bins based on a midpoint and an offset between a source and a receiver associated with the seismic traces;
for bins of the plurality of bins, estimating residual refraction statics characterizing the shallow subsurface anomalies by iteratively:
encoding, by a classical portion of the hybrid classical and quantum solver, a pair of discrete time shifts which are represented by a single binary variable per seismic trace to form a binary partition;
determining, by the classical portion, cross-correlations between the seismic traces in the bins to form an objective function for the binary partition based on the encoded discrete time shifts, wherein the objective function for the binary partition includes a constant term; and
determining, by a quantum portion of the hybrid classical and quantum solver, a set of discrete time-shifts representing the residual refraction statics that maximize stack power for the bins by maximizing the objective function, wherein a next iteration is initialized, by the classical portion, with a different set of time-shifts than a current iteration; and
performing refraction-based surface-consistent phase correction to each seismic trace by applying the estimated residual refraction statics.

9. The system of claim 8, wherein the operations further comprise:
causing control of hydrocarbon extraction equipment based at least in part on the corrected refraction-based surface-consistent phases.

10. The system of claim 8, wherein the single binary variable per seismic trace represents two different choices for time-shifts selected from a set of possible time-shifts.

11. The system of claim 10, wherein a first choice of the two choices represents a preferred time-shift determined by a previous iteration of maximizing the objective function.

12. The system of claim 11, wherein a second choice of the two choices is randomly selected from the set of possible time-shifts.

13. The system of claim 8, wherein determining a set of discrete time-shifts representing the residual refraction statics that maximize stack power for the bins further comprises:
determining that a value of the time-shifts for one of the seismic traces is near the maximum or the minimum of a range of possible time-shifts; and in response, shifting all of the time-shifts for the bin by a specified amount.

14. The system of claim 8, wherein iteratively maximizing the objective function occurs for a predetermined number of iterations.

15. One or more non-transitory, machine-readable storage devices storing instructions for detecting shallow subsurface anomalies in a subsurface formation, the instructions being executable by one or more processors, to cause performance of operations comprising:
obtaining seismic data for a subsurface formation;
forming one or more seismic gathers by sorting seismic traces from the seismic data into a plurality of bins based on a midpoint and an offset between a source and a receiver associated with the seismic traces;
for bins of the plurality of bins, estimating residual refraction statics characterizing shallow subsurface anomalies by iteratively:
encoding, by a classical portion of a hybrid classical and quantum solver, a pair of discrete time shifts which are represented by a single binary variable per seismic trace to form a binary partition;
determining, by the classical portion, cross-correlations between the seismic traces in the bins to form an objective function for the binary partition based on the encoded discrete time shifts, wherein the objective function for the binary partition includes a constant term; and
determining, by a quantum portion of the hybrid classical and quantum solver, a set of discrete time-shifts representing the residual refraction statics that maximize stack power for the bins by maximizing the objective function, wherein a next iteration is initialized, by the classical portion, with a different set of time-shifts than a current iteration; and
performing refraction-based surface-consistent phase correction to each seismic trace by applying the estimated residual refraction statics.

16. The non-transitory, machine-readable storage devices of claim 15, wherein the single binary variable per seismic trace represents two different choices for time-shifts selected from a set of possible time-shifts.

17. The non-transitory, machine-readable storage devices of claim 16, wherein a first choice of the two choices represents a preferred time-shift determined by a previous iteration of maximizing the objective function.

18. The non-transitory, machine-readable storage devices of claim 17, wherein a second choice of the two choices is randomly selected from the set of possible time-shifts.

19. The non-transitory, machine-readable storage devices of claim 15, wherein determining a set of discrete time-shifts representing the residual refraction statics that maximize stack power for the bins further comprises:
determining that a value of the time-shifts for one of the seismic traces is near the maximum or the minimum of a range of possible time-shifts; and in response, shifting all of the time-shifts for the bin by a specified amount.

20. The system of claim 15, wherein iteratively maximizing the objective function occurs for a predetermined number of iterations.
